(19) United States
(12) Patent Application Publication
(10) Pub. No.: US 2011/0167402 A1
(43) Pub. Date: Jul. 7, 2011

(54) Generic Framework for Accelerated Development of Automated Software Solutions

(76) Inventor: Shahbaz Ahmad, East Stroudsburg, PA (US)

(21) Appl. No.: 12/972,455

(22) Filed: Dec. 18, 2010

Related U.S. Application Data
(60) Provisional application No. 61/291,895, filed on Jan. 2, 2010.

(51) Int. Cl. G06F 9/44; G06F 17/30

(52) U.S. Cl. 717/101; 707/802; 707/E17.005

(57) ABSTRACT

A simplified software solution framework facilitating rapid development of automated solutions is introduced. The main concept behind the framework is a simplified approach towards database design with entities having concatenated character separated (CSV) strings of foreign keys pointing to the primary keys of their related child entities. This representation is applicable to all types of database relationships including one-to-many and many-to-many relationships, thus eliminating the need for junction tables.

The resulting encapsulation of the database entity with data and its relationships brings about cohesiveness among the data layer, business layer and presentation layer of the application. A framework with the new approach demonstrates how domain objects can flow across application layers in their own swim-lanes with minimal interference among each other.

### CROSS-REFERENCE TO RELATED APPLICATIONS

Provisional Application No. 61/291,895. Filing Date: Jan. 2, 2010.

Title: A Generic Framework for Accelerated Development of Automated Software Solutions

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Computer program listing is provided as a separated text file

‘Framework_{—}1.0_EntityB_Source.txt’ as a application part.

### BACKGROUND OF THE INVENTION

One of the many problems faced during software development is that there is no easy way to map business domain entities to the database entities because of incompatible type systems. Databases have historically been always designed to have entity relationships as foreign keys which refer to the primary keys of other entities. Many-to-many relationships require the use of join tables which have two foreign key fields referring to the primary keys of the two related tables. With this approach of representing relationships, the database entities do not seem to contain complete information about themselves. They are missing their relationship data with other entities.

As database entities don't cleanly map into the business layer, it is difficult to effectively build an integrated layer representing business objects and their relationships without some type of an object relational mapping layer. The ORM layer frequently is not able to fully resolve the impedance mismatch problem which continues to cascade to the user interface layer, where the objects and their relationships are difficult to be rendered and updated without complex logic and presentation patterns.

Considering the above mapping difficulties in the different tiers of a software solution, there is a need to have a fresh look at the structure of the database entity relationships in order to bring about uniformity in the entities of the three layers and simplify the solution as far as possible.

The present invention is a step in this direction.

### BRIEF SUMMARY OF THE INVENTION

The main concept behind the invention is a simplified approach towards database design which makes the database entities more cohesive with the object oriented entities in the business layer.

This is achieved by making a simple change in the basic way database tables represent relationships with foreign keys. The premise is that if database entities store concatenated strings of character separated foreign keys pointing to the primary keys of all related child entities, it will simplify the interface between the data layer and the business layer. This representation is applicable to both one-to-many and many-to-many relationships, thereby eliminating the need for junction tables and reducing the need for data layer ORM tools such as entity relationship frameworks etc.

This entity encapsulation approach with data and its relationships together in a single entity, can simplify the functionality of business layer collections. They can now directly query their corresponding entity tables in the database for loading and updating of entities with little or no in-between data layer. The one-on-one mapping can be taken further to the user interface layer, where the user interface can be modularized to enable standardized rendering, update and adding new entities to the database by updating a row of a single database table compared to updating multiple tables.

A framework with the above concepts that is customizable to meet a large spectrum of business needs has been implemented in MS Excel VBA. The primary objective is to provide a platform for domain experts and VBA savvy users for rapidly developing automated solutions of their needs. The framework may be initially useful for developing interim solutions for small to medium evolving processes which show promise of maturity. The solution with its business logic can be migrated to other environments as customer needs outgrow the current environment.

### BRIEF DESCRIPTION OF THE SEVERAL VIEWS OF THE DRAWING

FIG. 1 depicts the conceptual swim-lane type entity data flows between DB to UI via Domain Model in the Framework.

FIG. 2A illustrates the first of the two ways many to many relationships can be represented in the database tables.

FIG. 2B illustrates the second of the two ways many to many relationships can be represented in tables.

FIG. 3A illustrates the first of the two ways one to many relationships can be represented in database tables.

FIG. 3B illustrates the second of the two ways one-to-many relationships can be represented in database tables.

FIG. 4 illustrates the generic entity details form of the Framework.

FIG. 5 illustrates the child side details of the generic entity form of the Framework.

FIG. 6 shows the three pre-existing entities of the framework each having three code sections. EntityA has a commented out parent relationship section because it doesn't have any parents. EntityC has a comment out child relationship section because it does not have child relationship.

### DETAILED DESCRIPTION OF THE INVENTION

A few terms are used frequently in this section. Therefore it is appropriate to define them here.

### DEFINITIONS

Entity is a phrase frequently used phrase in this section. Used in a broader context, an entity can be encapsulated into an object with its own properties, methods and events. As part of the business layer, a domain entity may a business entity; it could be a scientific or engineering entity or a system entity supporting the computer implementation of the solution. As part of the data layer, a database entity may represent a domain entity as a database table row.

Parent Entity: An Entity class may contain collections of other entity classes. In such case this entity will be a Parent entity to the entity it contains. The definition also applies to database entities where a parent entity is that which contains the concatenated CSV string of foreign keys of its child entities.

Child Entity: If an entity class is contained within another entity class, this entity will be called the child entity for that entity. For databases, the child entities have their primary keys represented as concatenated strings of foreign keys in their parent entity.

A Parent entity for one entity may also be a child entity for another entity.

### Structure of the Framework

The present invention introduces a new and simplified approach to software solution design and proves the concept by implementing the new approach as a framework in MS Excel VBA. The Framework is comprised of the three logical layers namely the data, business logic, and presentation layer. The database layer is physically separate and may be on a computer network to provide multi-user support. The business layer, the presentation layer and other crosscutting features are within an Excel workbook as VBA code.

The core unique feature of the Framework is that it operates on a new and simplified database schema design. The database schema of the Framework has entity tables with foreign key fields containing character separated string of multiple foreign keys which refer to the entity's one-to-many or many-many relationships. This form of representation of foreign keys has many advantages. Firstly it simplifies the database design by eliminating the need of join tables for many-to-many relationships. Secondly, it serves towards creating an improved mapping of database entities with the business layer entities. Furthermore, combining of entity data and its relationship data into the entity itself is in line with the basic object orientation principle of encapsulation.

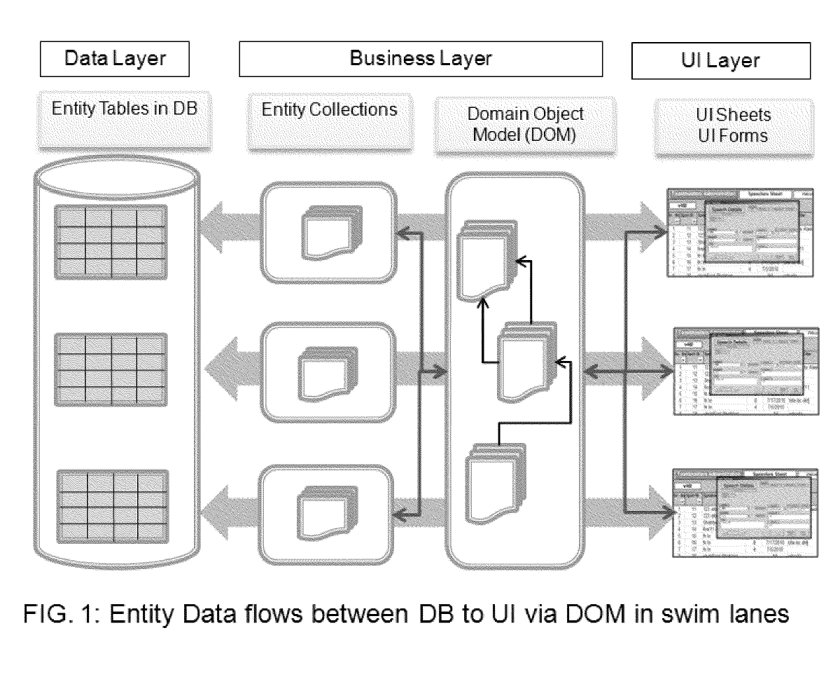

FIG. 1 depicts a conceptual flow of entities between the three application layers. Each business layer object collection interfaces with its own corresponding database entity with minimal interference. This swim-lane type independent flow of business entities may be taken to the presentation layer where each entity and its parent and child relationships are handled from a single UI object for display and update in a modular fashion.

The domain object model is now for the most part, able to cleanly map its domain entities to the database table entities. Thus, the domain model entities can cleanly access, update and add new entities to the corresponding database table entities with no additional mapping layer in between. As the entities are loaded, the domain model is constructed as a set of entity collections. The concatenated strings of foreign keys loaded from the database are used to construct related child object collections within parent objects. While doing so, the entities of the business domain model implicitly validate referential integrity for all of their children.

The domain model is then used to display its entities on the user interface. For situations where the domain model and the user interface are on the client, tight coupling between the two can be made such as done in the MS Excel based example framework.

Most domain entities have similar requirements for browse and update by users. Many entities require flexibility for the user to be able to update their child and parent relationships from both the child and parent entity forms. The Framework has a modular structure which provides this feature in a seamless manner.

The Framework is designed with modularization as its main strength. All modules of the business layer and the presentation layer have identical code for the same functionality. Hence new entities can be seamlessly added to the framework by following well defined steps such as changing the name of the entities, adding modular sections for parent and child relationships, inserting the entity item variables at pre-defined placeholders.

The Framework's concepts, logic and structure are transportable to any programming language, software environment and database, after removing the dependencies of the Excel object model.

Salient features of each layer of the Framework are now described.

### Data Layer

The Framework can connect to any database with an ADO connection string. In its current implementation, it has a MS Access database as its business layer.

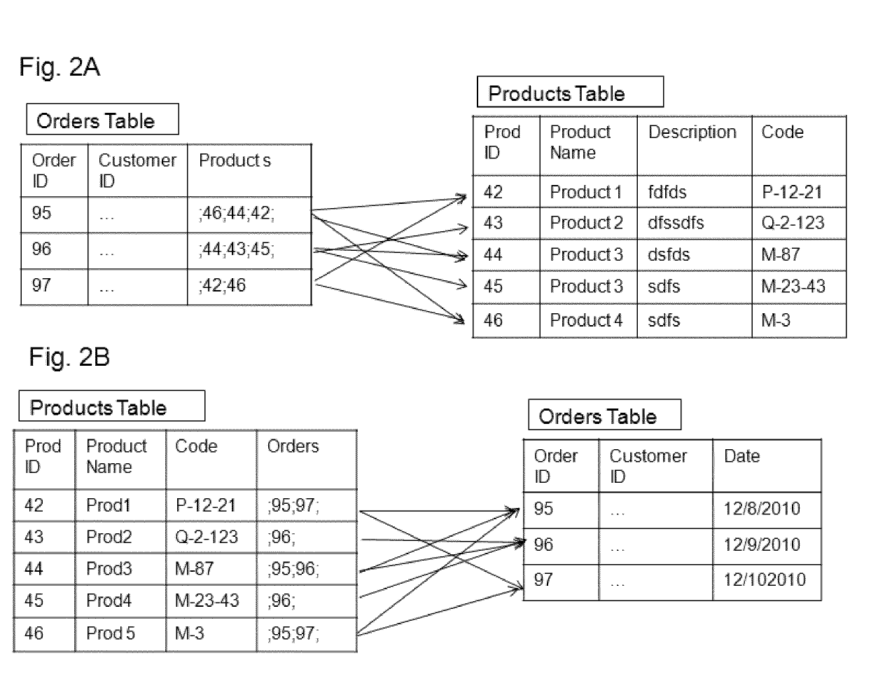

FIG. 2A and FIG. 2B depict the two new ways in which many-to-many information can be stored in the entity tables in the database. As an example, an orders table and a products table with only part of their attributes is shown. The relationship between these two tables is many-many, which means that one order can have multiple products and one product may belong to multiple orders. Conventionally this relationship would need a join table with which both of these entities have a one-many relationship. The new approach shown in FIGS. 2A and 2B eliminates the need for a join table by concatenating all the foreign keys of one entity into a character separated string in the foreign keys column of the other entity.

FIG. 2A shows that the foreign keys of the products table are referred in the Orders Table; whereas FIG. 2B shows that the foreign keys of the Orders table are present in the Products table. A logical way to decide upon which entity should be used for referring the foreign keys of the other and thus become the ‘Parent’ entity to the other is to see how the user of the system would prefer to update the relationship. In this particular example, the user will always be updating the Orders entity for updating the products it contains. Hence it is logical to assign the Orders entity as the parent entity and place the product foreign keys in the orders entity.

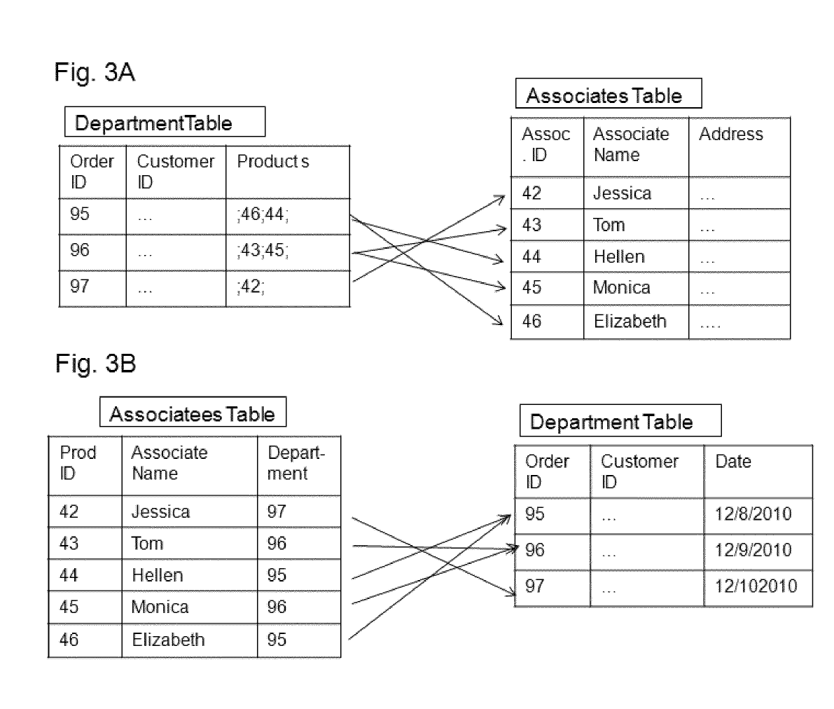

FIGS. 3A and 3B show a similar approach with 1-Many relationships. As an example, a Department entity and an Associate entity have a 1-Many relationship. A department can have several associates but an associate can not belong to more than one department. As with the Many-Many example, the foreign keys can be placed in any of the two entities (FIGS. 3A and 3B) with the difference that if the foreign keys are placed in the department entity (the one side), they will be concatenated multiple foreign keys, but if placed in the associate entity (the many side), a single foreign key will be sufficient which is similar to how foreign keys are presently handled. Deciding upon which of the two options is more appropriate can depend on which entity is the preferred one for the user to update the relationship. In the current example, the user may prefer to have the ability to update from both entities. Hence any of the two options is fine. In many one-to-many relationships, such as a file having several functions with each function belonging to a single file, placing the concatenated foreign keys in the File entity makes more sense because making a function part of the file seems to be more logical than making a file a part of the function.

Other uses of the character separated strings may also be used to code multiple subfields in one table field. For example, an address book entry that represents a single person may need zero or more phone numbers or zero or more addresses. This can be handled in business tier code via split and join string functions to convert these entities into objects and back to strings

String based coded information in databases can be used in several ways. Character separated sets of associated values can actually represent complex structures relationships which may be decoded at the Business layer level and seamlessly made part of the object model. For example, a project activity may involve people working on different tasks at different times for different durations. For a project entity, such a representation may take the form of a concatenated string such as “;W21,31,1.5D;”. The business tier splits the string and determines that for this particular project, the employee with ID 31, worked for 1.5 days during week 21 of the project.

As will be seen in the following sections, this approach of concatenation of character separated keys in parent entities to represent child entities not only simplifies the database design, but also simplifies the business and presentation layers in a significant way.

### Business Layer

The business layer of the Framework is contained in Excel VBA classes. Each entity is a class and its associated collection class. For solutions that do not require extensive data, an eager loading approach may be appropriate. The domain model with full data loading at application launch may be an effective strategy. All entity relationships are created while the entities are loaded into the model. For large databases, a partial model with lazy loading philosophy may be appropriate on an ‘as needed’ basis depending on what objects and what segment of objects need to be available.

The entities in the database have self contained relationship information within themselves. The load( ) functions of the domain entity collections load all data into their collections. When all entities have been loaded, the BuildObjectModel( ) of entity collections links up the collection classes with their parent and child relationships. The BuildObjectModel( ) function first calls the BuildChildEntityObjects( ) to create child objects of the entity from the concatenated Character separated string of foreign keys representing the child entities. Then it creates child collections for the entity. Alternatively, if the parent entity is on the M side of the 1-M relationship, a simple object reference is sufficient to depict the relationship with the other entity of the relationship. The BuildObjectModel( ) also ensures that referential integrity is maintained at all times.

Each entity collection has an Update( ) method which gets called when an entity needs to be updated. After ensuring that it has not been updated by another user since it was last loaded, the function goes ahead and updates the entity in the database. All child entity relationships, being part of the entity are also handled by the same method.

Each entity collection has an Add( ) method which gets called when a new entity needs to be added to the collection and to the database. After checking that the table has the same number of records as when the collection as last loaded, it goes ahead and adds the new entity to the collection and also to the databases. All child entity relationships, being part of the entity are also handled by the same method.

Deletion of the database entities can be handled by flagging the entity after ensuring it has no parents. The flagged records can either be used later for new additions or deleted by a cleanup tool.

### User Interface Layer

The User Interface layer of the Framework is bound to the Excel object model to take advantage of its user interface features, such as range names to save settings, worksheets to display entities as list and forms for lookup and update of entity details.

The benefit of clean separation of entity data originating from the database entity relationship encapsulation is derived at this layer too. Each entity can be treated in a similar manner with similar functions to load entities into sheets and forms, load their one-to-many and many-to-many parent and child relationships into list boxes with ‘add’, ‘remove’, ‘show details’ and ‘move up in order’ functionality for each relationship.

Updating of parent entities and their child relationships is a straight forward process as all relationship data is also part of the same parent entity. In cases where there is a user need to update the parent relationship from a child, then there will be a need to cross the swim-lane and update the parent entity.

Entity Details forms have three modes namely a Browse mode, Update mode and a New mode. In Browse mode, the user browses the entities while navigating the entity list of the sheet with the modeless form open. In Update mode, the user edits the entity fields and updates them to the database. In New Entity mode, the user creates new entities on the form and adds them to the database.

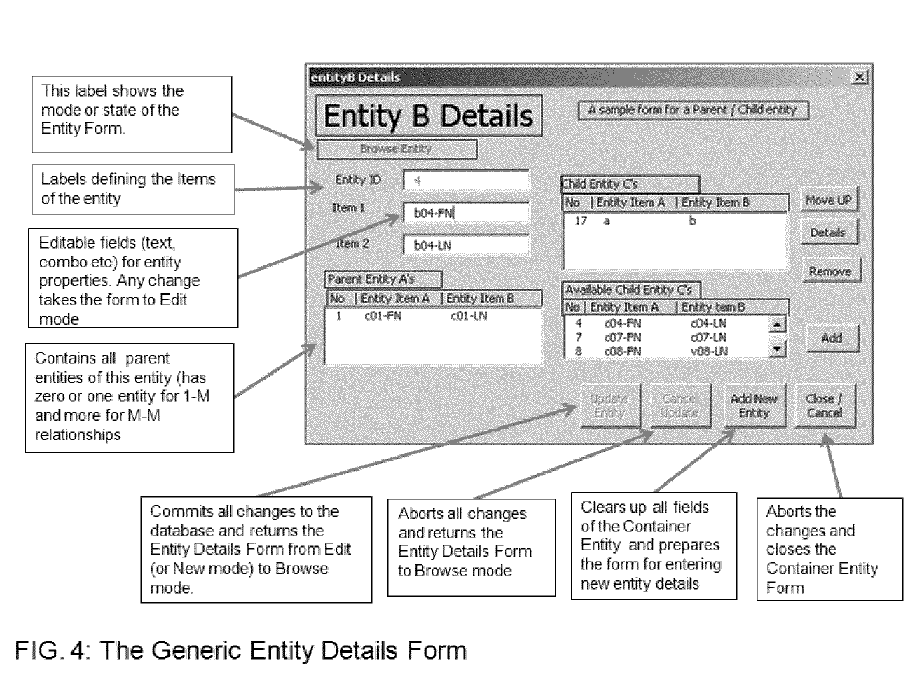

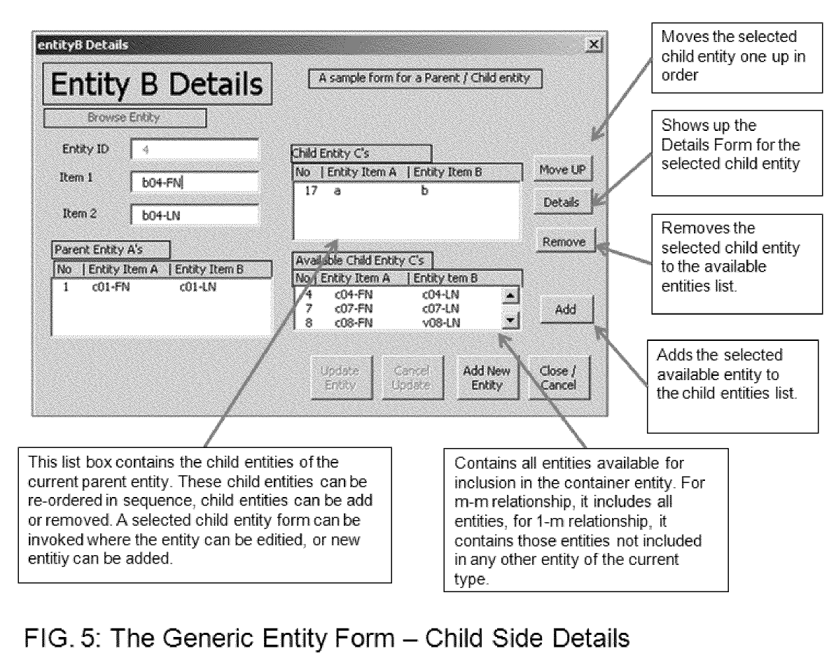

FIG. 4 and FIG. 5 show a generic ‘Entity Details Form’ of the Framework. FIG. 4 explains the details of the UI controls of the entity itself while FIG. 5 explains the controls related to display and update of its child relationships. The figures are self describing with explanation for each control.

### Other General Cross-Cutting Features

The implemented features of the framework not related to a particular layer are briefly described here.

In the current Excel implementation, security is handled via the Windows Login Name. For authenticating and authorizing a user, the administrator creates a new UserAccount entity with the Windows login name and assigns the entity a user role (admin, user, guest etc).

Authorization of user for various user groups is controlled by a customizable function in each entity form module. This function locks or unlocks user controls based on the group the logged-in user belongs to.

The database table ‘Updatelog’ is reserved for logging all the changes the users make to the database. At each successful update of the database, an entry is made to this table. The columns of this table are
Date Time: The date and time of change.
Login ID: The user who made the change.
TableID: The table in which a change was made.
EntityID: The entity to which the change was made or the id of the new added entry
Change: A character separated string containing changes made to the entity.

A dedicated sheet is available to browse the audit history. This feature is available to Admin user group.

User settings such as network location of the database are all local to the Framework workbook

Usage logs record the usage of the framework via the Userlog table of the framework. This log saves the time a user logged in, the user ID and the time a user logged out.

Toolbar buttons are available to provide functionality for refreshing the database, activate worksheets, entity details forms or the Settings form.

### Framework Customization Process for Creating Excel Based Solutions

This section outlines a step by step process for converting the Framework into a custom Excel based solution from a domain design in a systematic and controlled manner.

There are three dummy entities already existing in the Framework, with long names EntityA, EntityB and EntityC and short names ‘eA’, ‘eB’ and ‘eC’ respectively. Each of the three entities has two properties ‘EntityItem_{—}1’ and ‘EntityItem_{—}2’ which appear in code placeholders for adding new attributes or properties.

The three entities of the Framework are related to each other, with EntityA as parent of EntityB while EntityB is the parent of EntityC. Therefore in the database, EntityA has a field named ‘EntityBs’ representing a set of foreign keys of its child EntityBs, while EntityB has a field named EntityCs which represents a set of foreign keys of its child EntityCs.

Each of the three entities are implemented in the Framework as five separate VBA modules, a class module, a collection module, a form module, a ‘control events’ module (handling the form events), and a worksheet module.

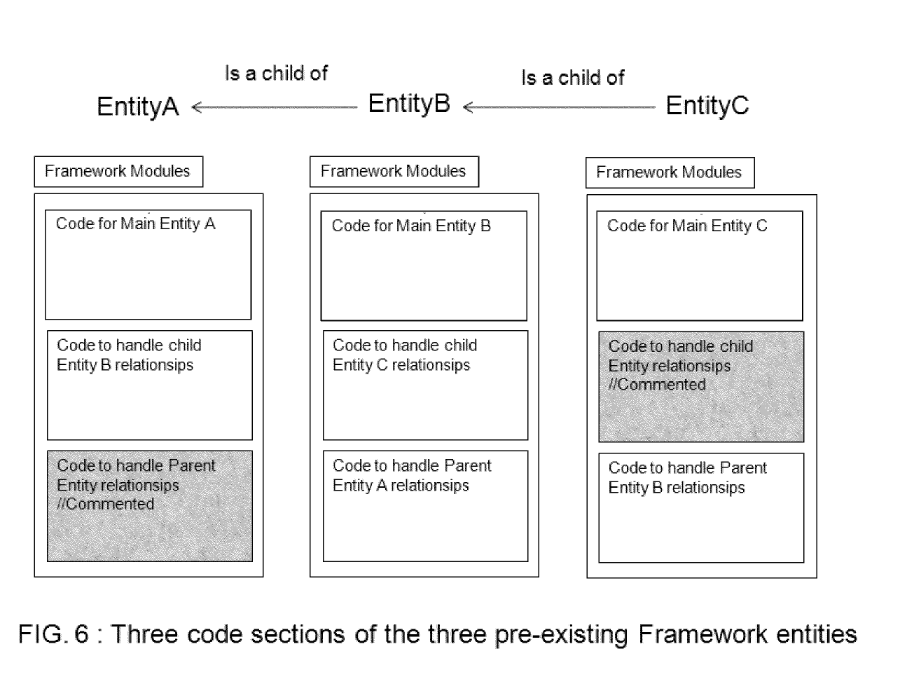

The three entities have similar code for all of the five modules, except for the place holders where the entity names (long and short) are referred. Furthermore, the code for each entity in three of the five modules (form, class and collection) have three sections, one for the main entity's code, the second section for its first child entity relationship code, and the third for its first parent entity relationship code. EntityA, having no parent, has a commented out parent relationship code section. Similarly EntityC, because it has no child relationship, has its child relationship code section commented out. EntityB having both a child and a parent relationship has both of these sections available and uncommented. This is diagrammatically depicted in FIG. 6.

The user can work with these three entities via the Framework's UI where they can be browsed, edited and updated. The user can add new entities also update the entity's child and parent relationships For example, EntityA's child entities can be updated from EntityA's form or the EntityB's parent relationship (which represents the same relationship) can be updated from EntityB's form.

As will be explained in the following sections, EntityB which has both a parent and child relationship will serve as a template by custom solution developers for substituting their own custom entities into the Framework.

The following three phases of customization will provide a walk through on how a developer will proceed on creating a custom solution by adding custom entities into the framework one at a time. Phase I is about getting the big picture on what is needed, defining custom entities, their custom functionality and their relationships, Phase II is about implementing the defined custom entities and their relationships into the framework and ensuring the framework is error free. The last Phase III will cover the process for adding the entity items or properties of the custom entities into the Framework. Completion of the three phases will potentially turn the Framework into a substantial first solution that is, with minimal testing, ready to be deployed for use. The completeness of the solution will depend on the completeness of the design model used for input. More changes will of course come, and the system will be ready to evolve with progressive updates in a modular fashion.

### Phase I: Defining the Object Model

### I.1. Identify Requirements and Define Domain Entities

The user identifies the need for an automated process and collects basic requirements on the objectives and needs. As the user decides to go ahead with developing a custom solution, hence from now onwards referred to as a developer, defines the main entities of the solution. Each entity is then assigned a long name and a short name. Long names should uniquely describe the entity while the short name will be used for entity variables used frequently in code. As an example for a long and short name, a ‘customer’ entity can have ‘Customer’ as a long name ‘csT’ as a short name. Using a mix of lower case and upper case is beneficial because it will help in identifying custom variables conveniently in code wherever they are substituted.

The developer then defines a high level custom functionality each entity may contain. This will be the custom code added to the entity class or its collection in Phase III. All attributes or properties for the entities are also defined. A product may have a name, a description and quantity as some of its properties. The entity attributes will be added into the framework after all the entities have been implemented and tested.

I.2. Identify Relationships Among Entities with a Domain Object Model Diagram.

As the entities are defined, the developer will identify relationships among them and represent them in a object model diagram. For each of the relationship, the developer will identify which of the two entities in the relationship is to be the parent entity for the other, that is, the one containing the relationship data.

### Phase II: Implementing the Entities

In Phase II, the developer will implement the entities defined in Phase I. One entity will be taken at a time and implemented before the next is taken up. This will be a controlled step by step process beginning with an Export/Rename/Import process for the form, class and its collection. The worksheet can be directly copied into a new sheet and renamed. Then search and replace for each of the new entity to be created, its child entities and parent entities.

The developer needs to establish bottom-up order for implementing the new entities in the Framework. Entities which do not have child entities should be the first to be implemented, so that when their parent entities are implemented, the child entities will be available to integrate and compile.

Here are the specific steps for the developer to follow for implementing each new entity in the given order. For reducing repetitiveness of the entity name abbreviations, the new entity being implemented will have <EntityName> as its long name and <eN> as its short name.

1. The first step is to create a new DB Table for the new entity in the database. Open the given Access database ‘Framework.mdb’, copy EntityBs and paste it back by renaming it to <EntityName> with paste options selected as ‘Structure and Data’.

2. Export the 4 VBA project modules of EntityB (formEntityBs, ControlEventseB, EntityB and EntityBs); copy the wksEntityBs into a new sheet.

3. Rename the EntityB project modules as follows:
The class EntityB to <EntityName>
The class collection: EntityBs to <EntityName>s
The class ControlEventseB to ControlEvents<eN>
The form: formEntityBs to form<EntityName>s
The worksheet: wksEntityBs to wks<EntityName>s. Worksheets are copied and pasted rather than exported.

4. Import the exported modules back into the VBA project.

Once this set of five modules is created, the developer carries out the following steps for each of the newly created modules.

5. This is the main step that is divided into 8 sub steps that deal with making changes to the code for each of the renamed modules of the code for each entity

5.1. Within the module's code, search for the text ‘EntityB’ and replace it with ‘<EntityName>’, the long name for the new entity.

5.2. Within the module code search for the text ‘eB’ which is the short name for EntityB, and replace with <eN>, the short name for the new entity.

5.3. If the entity does not have a child relationship, comment out code Section 2, the child relationship section of the module. Also comment out the placeholder entries with the name ‘PH:For each child’. Skip steps 5.5 and 5.7 in such case

5.4 Similarly if the entity does not have a parent entity, comment out code Section 3, the parent relationship section of the module and also the code within ‘PH:For each Parent’. In such case, Skip steps 5.6 and 5.8 in such case.

5.5. For the first child relationship, replace ‘EntityC’ with the child's long name <EntityName> and replace ‘eC’ with the child's short name <eN>.

5.6 For the first parent relationship, replace ‘EntityA’ with the parent's long name <EntityName> and replace ‘eA’ with the parent's short name <eN>

5.7. The entity may well have more than one child relationship. In such case, for each additional child relationship, copy the child relationship section from the original (re-imported) EntityB module and replace all instances of ‘EntityB’ with <EntityName> of the new entity, ‘eB’ with <eN> of the new entity, ‘EntityC’ with <EntityName> of the additional child entity and ‘eC’ with the <eN> of the additional child entity.

The module code has placeholders with names ‘PH:For each Child . . . ’. These placeholders have declarations or function calls to the child relationship functions. For each child add a function or statement similar to the already existing for EntityC with <EntityName> of the additional child entity.

Furthermore, for each additional child relationship, copy the 2 list boxes and the four buttons for the existing child relationship on the entity form form <EntityName>s and rename the controls, replacing ‘EntityC’ with <EntityName> of the additional child entity. Use multipage controls for extra space on the form

5.8. Entity may have more than one parent relationship. In such case, for each additional parent relationship, copy the parent relationship section from the original (re-imported) EntityB module and replace all instances of ‘EntityB’ with <EntityName> of the new entity, ‘eB’ with <eN> of the new entity, ‘EntityA’ with <EntityName> of the additional parent entity and ‘eA’ with the <eN> of the additional parent entity.

The module code has placeholders with names ‘PH:For each Parent . . . ’. These placeholders have declarations or function calls to the parent relationship functions. For each parent add a function or statement similar to the already existing for EntityC with <EntityName> of the additional parent entity.

Furthermore, for each additional parent relationship, copy the 2 list boxes and the four buttons for the existing Parent relationship on the form and rename the controls, replacing ‘EntityA’ with <EntityName> of the additional child entity. Use multipage controls for more space.

Go to step 6 only once you have completed changes to all modules for the entity.

6. There are six placeholders in the Globals module. Once the new entity declarations are added to these placeholders, the entity can be instantiated and will become part of the executable code. These placeholders are:
PH:For Each Entity. Global Class Collections
PH:For Each Entity. Currently selected entity
PH:For Each Entity. Entity forms edit mode
PH:For Each Entity. Copy the following enum and paste it below this enum replacing
EntityB with the new <EntityName>
PH: For Each Entity. Instantiate the collections in DBLoad( )
‘PH: For Each Entity. Load the collections. Consider the parent child hierarchy for dependencies. Object model is built only if all child objects for a parent are available

Copy and existing entry of EntityB in the above placeholders, paste is on the next line and replace ‘EntityB’ or ‘eB’ with <EntityName> or <eN> respectively.

7. The final step needed for having the entity become part of the object model itself is to place code inside the BuildObjectModel( ) of the collection. This step may not be needed for each entity and you may want to wait before more entities are substituted into the Framework. Here is a generic code for the BuildObjectModel( ) function. Explanation and guidelines for making the changes in it will follow.

Sub BuildDomainModel( )

Dim eB As EntityB
Dim eA As EntityA
’now add eBs to eAs
For Each eA In cEntityAs.items ’assumed cEntityAs have been
loaded

Set eA.ChildEntityBs =
eA.BuildChildEntityBObjects(eA.ChildEntityBsString)
For Each eB In eA.ChildEntityBs.items

If Not eB.ContainsParentEntityA(eA) Then
’BuildObjectModel is called from

‘AddtoDB( ) too. hence to check for already existing.

Call eB.ParentEntityAs.Add(eA) ’add parents to
EntityB

End If

Next eB

Next eA

End Sub

The function creates child collections of EntityB within EntityA. Hence if the two entities have been loaded via the global DB load( ) function, this will work. Each of the entity collections has placeholder BuildObjectModel( ) functions. So, you may want to delay the building the object model till sufficient entities have been created inside the framework, then creating the model in one go. For larger databases will larger load times, the model may be loaded in parts depending on user needs.

8. If the entity is instantiated as part of the object model, test it along with the other existing entities and ensure the code is bug free. Then move on the next entity starting with Item 1.

At this stage, all entities are now implemented with their relationships but they are without their entity items. After ensuring that they are work correctly with each other for all functionality (update, add, add/remove child, add/remove parent), move on to Phase III where the entities and their items are elaborated.

### Phase III: Adding the Entity Items for Domain Entities.

This phase is a more solution specific phase than the earlier phases. In this phase, custom functionality and entity items are added to the entities in various modules. User interface decisions are made on how to display the items on the user interface. The entity forms which had a useful role in phase II to validate the default entity items and their relationships may be enhanced for each item to be displayed via user interface controls such as text boxes, drop downs, option or check boxes etc. The form may utilize multipage controls for more space. For some entities, worksheet may be a more appropriate for operating the application. There is considerable freedom for the developer to customize how entities are handled at the user interface level.

For each entity, entity items are added at defined place holders in various modules. The following 10 steps define all actions that need to be taken for implementing custom functionality into the solution.

1. Custom functionality, which could well be the main objective of creating a custom solution, is added to entities however needed. This may include making use of any of the following libraries and API′.
The Excel Object Model/Office model
Working with API's of other applications.
Calling custom built objects in other libraries built for functionality not available in VBA (e.g. multithreading)’
Connecting and accessing data from multiple databases.
Accessing hardware etc.
Windows API, WMI etc. and more . . . .

2. Add all entity items of the entity to its corresponding database table created in Phase II

3. In the class module of the entity add the entity items in the following two place holders
PH:For Each Entity Item. Create fields with clear naming conventions and with the required data types
PH:For Each Entity Item. Create a Property. Use clear naming conventions and Take care to match the data types

4. In the collection module of the entity, add the entity items in the following place holders.
PH: SQL Call for load.
PH:For each Entity Item. Add all entity items to load
PH:For each Entity Item. Add the items to the db (function AddtoDB)
PH:For each Entity Item. Add in the select query (function UpdateDB( ))
PH:For each Entity Item. Add to record changes in the DB (function UpdateDB( ))

5. Design the UI for the entity items. Could be either the form used in phase II, or a new worksheet UI designed to provide user friendly update feature. Use naming conventions as per the best practices for assigning names to controls.

6. In the Form module of the entity, add the entity items in the following place holders.
PH:For each Entity Item. New Entity fields need to be ready for new entries. btnAddNewEntityEntity( )
PH:For each Entity Item. Enter Validation functionality. ValidateUpdates( )
PH: For each Entity Item. Fill in the details form. FillFieldsWithDetails( ), using the UI control names assigned to form controls in step 5.
PH: For each Entity Item. Check for uniqueness of each item. Solution specific. CheckForUniqueEntity( )

7. In the Globals module, add the entity items to be displayed on the worksheet the enumerated column names in the following placeholder. created for the new entity in step 6 of phase II.

8. On the worksheet interface, create the corresponding columns as per defined in the enumeration.

9. In the Worksheet module of the entity, add the entity items in the following place holder.
PH:For Each Entity Item. Load the entity items on the worksheet columns as needed. LoadEntitieslnSheet( ). Use the enumerated column names that were assigned to them in step 6.

10. Test the entities and their items to ensure that
Entity's custom functionality is fully functional as designed with all interfacing entities working correctly.
All entity items are displayed correctly on forms and worksheets and updated correctly on the database.
All relationships are displayed and updated correctly. Cross check by verifying that when a child is added to a parent entity, the child's parent entities are also updated.

The above 10 steps may need to be revisited iteratively as custom functionality of step 1 may impose its own dependencies on entity persistence and UI design. The domain design or entity relationships may need to be modified, which will need iterations for Phase I and Phase II.

This completes the three phase step by step work flow for custom solution development using the framework. The process identified above is specific to Excel VBA environment. However, it can be adapted for any development environment and programming language. As the steps are by and large pre-defined and procedural, they can potentially by automated, thus opening up possibilities for automating a large part of the software development process.

While the invention has been described as it relates to the implemented features of the framework, it will be understood by those skilled in the art that various changes may be made without deviating from the spirit and scope of the invention as defined in the appended claims.

### Computer Program Listing

Entity B has five VBA modules in the framework which have been used in the framework customization process. Source listing from these modules plus the common global module are provided as a separate text file ‘Framework_{—}1.0_EntityB_Source.txt’ being part of this submittal.

What is claimed is:

1. A conceptual generic software framework for accelerated development of multi-user automated software solutions in any programming language, development environment, architecture or database.

2. The core concept behind the framework of claim 1 is a simplified approach towards database design with entities having concatenated character separated (CSV) strings of foreign keys pointing to the primary keys of their related child entities, rather than child entities pointing back the foreign keys to their parent's primary key.

3. The core concept of claim 2 is applicable to all types of relationships involving foreign keys thereby eliminating the need for junction tables and enabling the database table entities to provide an improved one-on-one mapping with the objects of the business layer.

4. The core concept of claim 2 significantly eliminates the need for object relational mapping tools thereby reducing complexity and improving performance; Object collections in the business domain model can access database tables to build the model and to update the database tables directly from their own object collection functions.

5. The framework of claim 1 is currently implemented as a desktop thick client, but the logic and functionality are implementable on any software technology or architecture including any language environment, compiled or scripted, desktop systems or web based applications.

6. The framework of claim 1 offers a standardized approach that defines an arrangement of parallel or swim-lane type flow of domain entity information via the Domain Model, to and from the database and the user interface.

7. The framework of claim 1 brings about order and structure to the process of application development, thereby raising the potential of automating a large part of the software development process, accelerating application development timelines, reducing testing effort while improving quality.

8. The framework of claim 1, in its current implementation in Excel VBA (with database in MS Access), provides placeholders in various VBA modules to substitute entity data from the domain model to create custom solutions from the domain model design.

9. The framework of claim 1, has been implemented using object oriented (OO) or object based design in Excel VBA environment for the purpose of introducing solution design concepts and best practices to business domain experts and Excel power users and providing an opportunity to them for developing solutions of their needs for their new and evolving business processes and practices.

10. The framework of claim 1 consists of a business layer containing classes representing business entities and their collections classes together with their relationships, with each entity capable of loading, updating and adding its own attributes and relationship data to the central database.

11. The business layer of claim 10 has a standardized mechanism of building object relationships with parent objects containing child object references or collections based on the parent entity's concatenated character separated foreign keys of child entities. This mechanism handles the building of domain entities with all types of database relationships using foreign keys.

12. The framework if claim 1 has a standard user interface for rendering, navigating, updating existing entities and adding new entities to the database.

13. The user interface of claim 12, because of the unified entity and relationship information, allows a flexible mechanism to update, add or remove child and parent entities of the current entity being updated.

14. The framework of claim 1 is controlled by a simple security and authorization model with entity update restriction applied for any entity based on the user group of the logged in user.

15. The framework of claim 1 has a standardized mechanism for audit trail, wherein any update taking place on the database has a corresponding update in a separate update log table with details of date time the update was mad, the logged in user, the entity ID the change was made and the new value of the entity item that was changed.

16. The framework of claim 1 provides a user log based on when a user logged in and logged out of the system.
